(19) United States
(12) Patent Application Publication
(10) Pub. No.: US 2009/0139799 A1
(43) Pub. Date: Jun. 4, 2009

(54) TEXTURED SURFACES FOR GEARS

(75) Inventors: Mayank Tiwari, Bangalore (IN); Prasad Raman Joshi, Bangalore (IN); Nikhil Subhashchandra Tambe, Bangalore (IN); Mandyam Rangayan Sridhar, Bangalore (IN); Harith Vadari, Hyderabad (IN); Hombe Gowda, Bangalore (IN)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/947,907

(22) Filed: Nov. 30, 2007

(51) Int. Cl. F16H 57/04; F16H 57/08

(52) U.S. Cl. 184/6.12; 475/331

(57) ABSTRACT

A gearbox includes a plurality of gear sets disposed within a gearbox housing. Each gear set includes at least two gears meshing with one another. Each gear includes one or more dimpled surfaces configured to hold lubricant for providing lubrication between the gears meshing with one another. A plurality of bearings is provided to support the plurality of gear sets.

### BACKGROUND

The invention relates generally to textured surfaces for gears, and more particularly, to dimpled surfaces for gears in a rotating machine, for example, gearbox in a wind turbine.

A gear is a machine part that is designed to mesh with another similar machine part to transmit rotational motion. The most commonly used gears include planetary gears, spur gears, helical gears, bevel gears, worm gears, and rack and pinion gears. Gears mesh with each other in many different ways to transfer motion from one gear to another. In addition, gears can be used to increase or decrease the speed of rotation. For example, a smaller gear driven by a larger gear will have a greater speed of rotation than the larger gear. Conversely, a larger gear driven by a smaller gear will have a lower speed of rotation than the smaller gear. Gears may be housed in a gearbox. Gearboxes are used to transmit rotational motion in many different types of systems. A gearbox typically consists of at least one gear set and bearings to enable the gears to rotate.

The gears and bearings in a gearbox may have defects, or they may fail over time, or they may simply wear out. For example, the loads and stresses that are imposed on the bearings and gears may exceed acceptable limits, leading to failure or damage to the gears or bearings. The damaged or failed components may be replaced once their existence is known. Alternatively, the teeth may simply begin to wear down through prolonged usage.

It is conventionally known that lubricants may be used in gear boxes for rotating machines to provide lubrication and reduce friction between meshing gears. In applications such as wind turbines, meshing gears operate under conditions such as lower speeds and higher loads. It is also known that the lubrication phenomenon is transient in nature in such applications. During transient conditions such as emergency stops of the machine, gears are subjected to further loads. As a result, sustaining the lubricant film between the gears is difficult. This results in insufficient lubrication and wear of the mating gears.

There is a need for effectively sustaining lubricant film between meshing gears in a gear box for enhancing lubrication in gears even during transient operating conditions of a rotating machine.

### BRIEF DESCRIPTION

In accordance with one exemplary embodiment of the present invention, a gearbox is disclosed. The gearbox includes a plurality of gear sets disposed within a gearbox housing. Each gear set includes at least two gears meshing with one another. Each gear includes one or more dimpled surfaces configured to hold lubricant for providing lubrication between the gears meshing with one another. A plurality of bearings is provided to support the plurality of gear sets.

In accordance with another exemplary embodiment of the present invention, a gear is disclosed. The gear includes one or more dimpled surfaces configured to hold lubricant for providing lubrication to the gear.

In accordance with yet another exemplary embodiment of the present invention, a wind turbine is disclosed. The wind turbine includes a gearbox provided between a rotor and a generator. The gearbox includes a plurality of gear sets disposed within a gearbox housing. Each gear set includes at least two gears meshing with one another. Each gear includes one or more dimpled surfaces configured to hold lubricant for providing lubrication between the gears meshing with one another. A plurality of bearings is provided to support the plurality of gear sets.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical view of a rotating electric machine having gearbox including a plurality of gear sets having one or more textured surfaces in accordance with an exemplary embodiment of the present invention;

FIG. 2 is a diagrammatical view of gear having one or more textured surfaces in accordance with the aspects of FIG. 1;

FIG. 3 is a diagrammatical view of a textured surface in accordance with an exemplary embodiment of the present invention;

FIG. 4 is a diagrammatical view of a textured surface configured for lubrication in gears in accordance with an exemplary embodiment of the present invention; and

FIG. 5 is a graph representing variation of pressure versus velocity for various applications involving dimpled lubrication in accordance with an exemplary embodiment of the present invention.

### DETAILED DESCRIPTION

As discussed in detail below, embodiments of the present invention provide a gearbox having a plurality of gear sets disposed within a gearbox housing. Each gear set includes at least two gears meshing with one another. Each gear includes one or more dimpled surfaces configured to hold lubricant for providing lubrication between the gears meshing with one another. In one exemplary embodiment, a wind turbine having the exemplary gearbox is disclosed. The surface texturing technique addresses problems associated with lubrication under extreme operating conditions by having dimples on the gear surfaces. The exemplary textured surface enhances lubrication even in an operating regime where there is a higher stress causing elastic deformation of the mating surfaces. The textured surfaces in the form of dimples for enhanced lubrication, addresses problems associated with lubrication, and enhance performance of the mechanical components with rolling and/or sliding contacts between them.

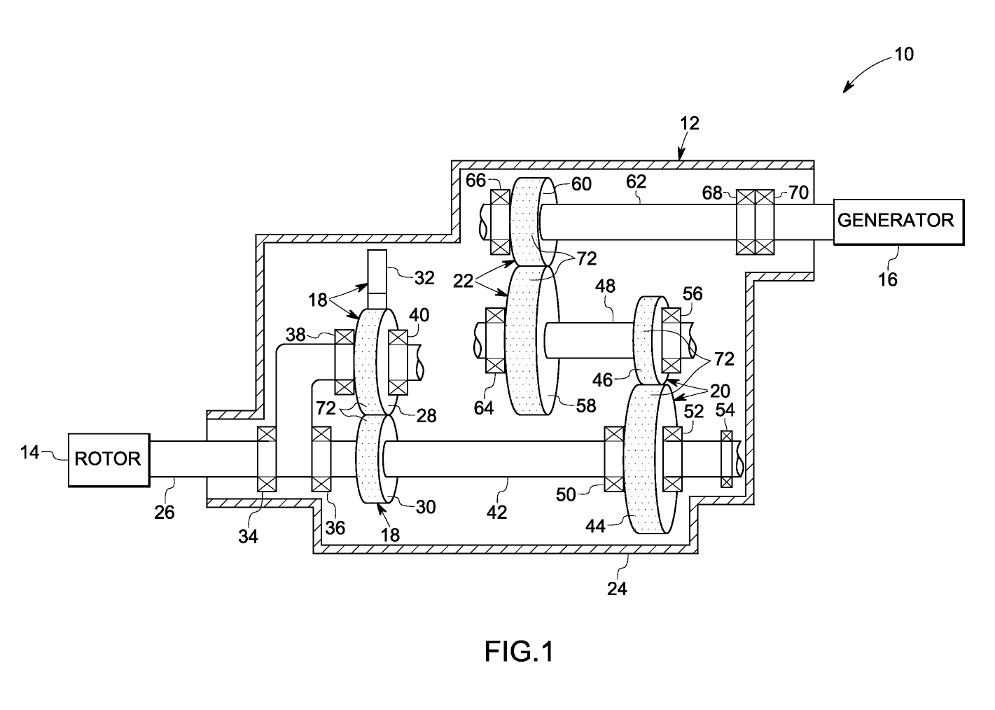

Referring generally to FIG. 1, a rotating electric machine is illustrated, and represented generally by reference numeral 10. In this embodiment, the rotating electric machine is a wind turbine. However the techniques described below are applicable to other power generation machines as well as various other applications. In this embodiment, the wind turbine 10 has a gearbox 12 provided between a rotor 14 and a generator 16. The rotor 14 has a plurality of rotor blades (not shown). As the wind blows, the rotor 14 is rotated due to the force of the wind. The speed of rotation of the rotor 14 may vary as a function of the wind speed. The rotation of the rotor 14 is transmitted via the gearbox 12 to the rotor of the generator 16. The rotor 14 is designed to transfer wind energy into rotation efficiently. However, the rotor of the generator 16 is designed to operate at a much greater speed. The gearbox 12 is designed to increase the speed of rotation produced by the rotor 14 to the more desirable speed for driving the rotor of the generator 16.

In the illustrated embodiment, the gearbox 12 comprises a planetary gear set 18, an intermediate gear set 20, and a high-speed gear set 22 provided inside a gearbox housing 24. The rotor 14 is coupled via a rotor shaft 26 to the planetary gear set 18. The planetary gear set 18 comprises a planetary gear 28, a sun gear 30, and a ring gear 32. The ring gear 32 extends around the sun gear 30 and has teeth around its inner circumference. The sun gear 30 has teeth around its outer circumference. The teeth of the planetary gear 28 mesh with the teeth of the sun gear 30 and the ring gear 32. In addition, the planetary gear 28 is coupled to the rotor shaft 26. As the rotor 14 rotates the rotor shaft 26, the planetary gear 28 is driven around the sun gear 30 causing the sun gear 30 to rotate. The planetary gear set 18 is supported by a plurality of bearings 34, 36, 38, and 40.

The sun gear 30 is coupled via a first gear shaft 42 to the intermediate gear set 20. In this embodiment, the sun gear 30 is smaller than the planetary gear 28 and rotates at a greater speed than the rotor shaft 26. Therefore, the gear shaft 42 also rotates at a greater speed than the rotor shaft 26. The intermediate gear set 20 comprises a first intermediate gear 44 and a second intermediate gear 46 that cooperate to increase the speed of rotation further. The second intermediate gear 46 is coupled to a second gear shaft 48 coupled to the high-speed gear set 22. The first intermediate gear 44 is larger than the second intermediate gear 46 so that the second intermediate gear 46 rotates at a greater speed than the first intermediate gear 44. Therefore, the second gear shaft 48 rotates at a greater speed than the first gear shaft 42. The intermediate gear set 20 also is supported by a plurality of bearings 50, 52, 54, and 56.

The high-speed gear set 22 comprises a first high-speed gear 58 and a second high-speed gear 60 that cooperate to increase the speed of rotation still further. The second high-speed gear 60 is coupled to the generator 16 via an output shaft 62. The high-speed gear set 22 is supported via corresponding bearings 64, 66, 68, and 70. The first high-speed gear 58 is larger than the second high-speed gear 60. Therefore, the second high-speed gear 60 rotates at a greater speed than the first high-speed gear 58. Consequently, the output shaft 62 rotates at a greater speed than the second gear shaft 48. The generator 16 converts the rotational energy of the output shaft 62 into electricity.

It is known conventionally that friction, wear, and lubrication are key parameters to control for enhanced life and reliable operation of many mechanical components. For low speed and high load tribological applications with rolling and/or sliding contact, such as between mating gears in the wind turbine gearbox, generating an appropriate film thickness for the lubricant is difficult and is thus a limiting factor when designing these components for longer life. In the illustrated exemplary embodiment, each gear of the planetary gear set 18, intermediate gear set 20, and the high-speed gear set 22 includes one or more dimpled surfaces 72 configured to hold lubricant for providing lubrication between the gears meshing with one another. As disclosed herein, “dimpled surface” may be referred to as a surface having a plurality of dimples or grooves formed in a predetermined pattern. The pattern may vary depending on the application. The dimples may be micro- or nano-sized dimples configured to hold lubricant for enhanced lubrication. Surface texture in the form of dimples on gear surfaces is an effective means for lubrication under conditions of elastic deformation of contact surfaces. As a result, friction and wear are substantially reduced in mating gears. Additional details pertaining to dimpled surfaces in gears, is explained in greater detail with reference to subsequent figures.

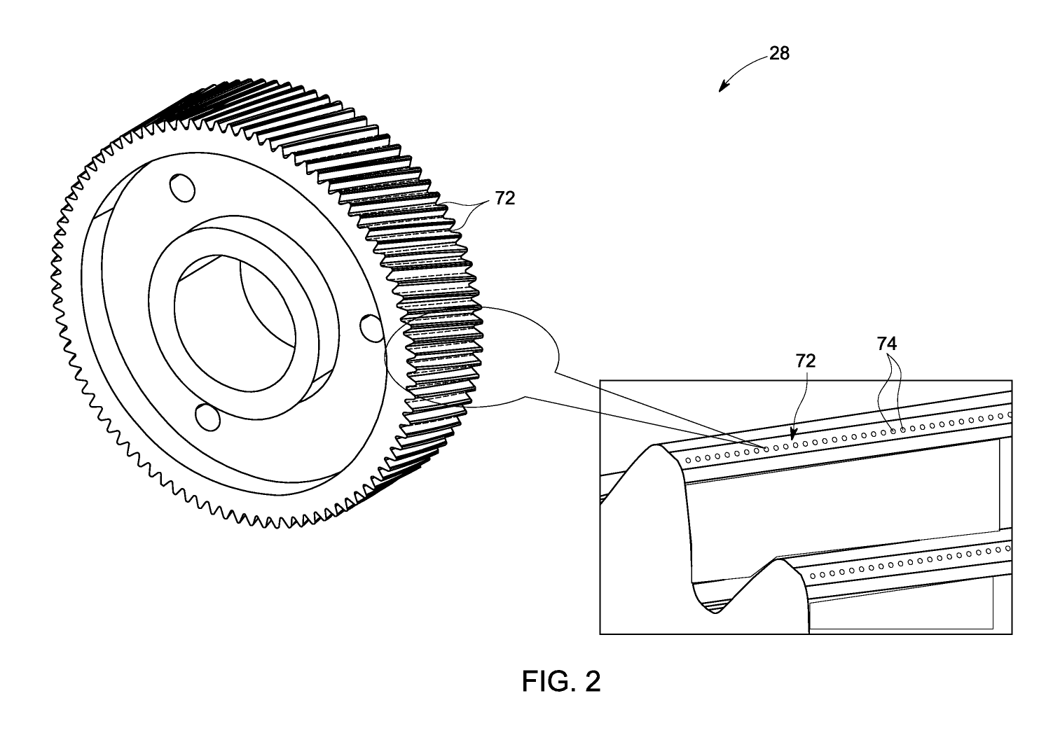

Referring to FIG. 2, the planetary gear 28 of the planetary set is illustrated. As discussed above, the planetary gear 28 includes one or more dimpled surfaces 72 having plurality of dimples 74 configured to hold lubricant for providing lubrication between the gears meshing with one another. Conventionally, gear surfaces are hardened and polished using well-known manufacturing processes without any additional features on the surfaces. In the illustrated exemplary embodiment, the surface texturing in the form of dimples enhances lubrication by providing improved availability of the lubricant.

During operating conditions when the supply of lubricant is often limited, the dimples 74 hold the lubricant at the dimpled regions on the surface 72 due to a surface tension. During operating conditions when the supply of lubricant is generally abundant, but a combination of load, speed, and geometry of gears is not sufficient to sustain a lubricant film between the gears, the dimples 74 act as “reservoirs” of lubricant. The dimples supply lubricant under pressure to the mating surfaces of the gears. As a result, a lubricant film is sustained between the gears even under adverse operating conditions of the machine. Even though the exemplary textured surface is explained in detail with reference to the planetary gear 28, the textured surface technique is equally applicable to other gears of the planetary gear set 18, an intermediate gear set 20, and a high-speed gear set 22, as well as other types of gears not shown or described for this particular example.

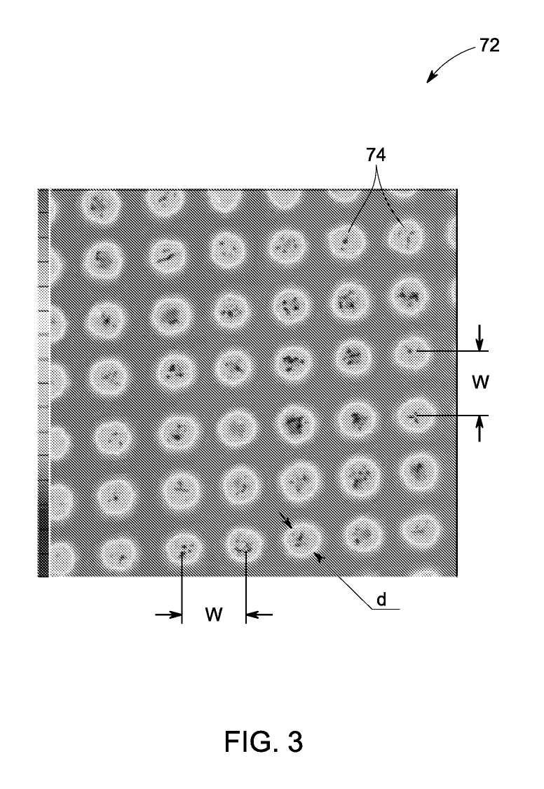

Referring to FIG. 3, the dimpled surface 72 in accordance with the aspects of FIG. 2 is illustrated. As discussed above, the planetary gear 28 includes one or more dimpled surfaces 72 having plurality of dimples 74 configured to hold lubricant for providing lubrication between the gears meshing with one another. The dimples 74 may be formed in a predetermined pattern. In one example, the predetermined pattern may include a grid-like pattern with regular spacing “w” between the dimples 74. In certain exemplary embodiments, the spacing between the dimples 74 may be in the range from about 50 microns to about 300 microns. In particular embodiments, the spacing between the dimples 74 may be in the range from about 150 microns to about 300 microns. In some exemplary embodiments, diameter of dimples may be in the range from about 50 microns to about 200 microns. In particular embodiments, diameter of dimples may be in the range from about 80 microns to about 150 microns. In certain exemplary embodiments, depth of the dimples may be in the range from about 1 micron to about 50 microns. In particular embodiments, depth of the dimples may be in the range from about 30 microns to about 50 microns. In certain other exemplary embodiments, the diameter of dimples may be in the range from about 50 microns to about 150 microns, the depth of the dimples may be in the range from about 5 microns to about 10 microns, and the spacing between the dimples 74 may be in the range from about 100 microns to about 150 microns. In another example, the predetermined pattern may include a grid-like pattern with irregular spacing “w” between the dimples 74. In yet another example, the pattern may include circular pattern. In yet another example, the pattern may be an irregular pattern. Similarly any number of patterns is envisaged. The pattern, diameter, depth, and spacing between the dimples may be varied depending on the application. The pattern, diameter, depth, and spacing may be varied depending on factors including geometry of gears, load acting on the gears, and velocity of the gears. The dimples may be formed by manufacturing techniques including but not limited to laser machining, water jet machining, abrasive jet machining, electrochemical machining, electro discharge machining, or a combination thereof.

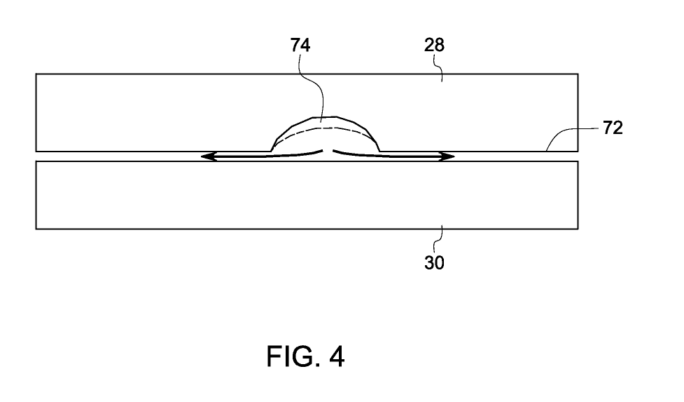

Referring to FIG. 4, the planetary gear 28 having a dimpled surface 72 with dimples 74 is illustrated in accordance with the aspects of FIG. 3. The planetary gear 28 is configured to mesh with the sun gear 30. In the applications such as wind turbines, gearboxes operate under low speed and high load conditions. As discussed previously, the exemplary dimpled surface enhances lubrication even in an operating regime where there is a sufficiently high stress to cause elastic deformation of the mating surfaces. In the illustrated embodiment, during adverse operating conditions, volume of the dimple 74 reduces due to pressure or elastic deformation. The dimples 74 act as “reservoirs” of lubricant. When there is an elastohydrodynamic effect (volume change), the dimples supply lubricant under pressure between the mating surfaces of the gears 28, 30. As a result, a lubricant film is sustained between the gears even under adverse operating conditions of the machine.

In accordance with the exemplary embodiments, dimpled surface in gears leading to substantial reduction in friction over a wide range covering boundary to mixed lubrication conditions between contact surfaces of gears. It should be noted herein that boundary lubrication occurs when a fluid fails to develop into a complete fluid film (i.e. hydrodynamic lubrication, allowing occasional contact between high points, known as asperities, of sliding wear surfaces. The mixed lubrication regime includes both elastohydrodynamic and boundary lubricated regions. Dimples reduce friction over boundary and mixed regimes, with normal lubricants, which do not have additives. Normal lubricants without additives are preferred to avoid tribochemical reaction leading to degradation of contact surfaces of gears. Also, micro dimples whose scale is equivalent to, or smaller, than a contact line width between the mating gears may also be used. The dimple geometry may include rounded, and angular profiles. In some embodiments, the other dimple geometries are also envisaged.

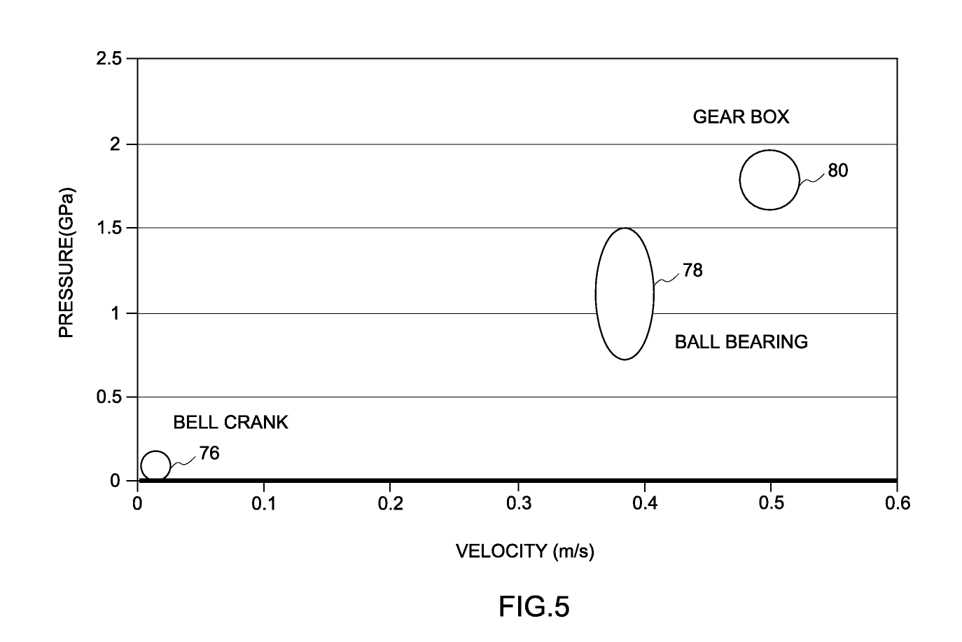

Referring now to FIG. 5, a graph representing variation of pressure (expressed in Gigapascals (GPa)) versus velocity (expressed in meters per second (m/sec)) for various applications involving dimpled lubrication is illustrated in accordance with an exemplary embodiment of the present invention. It should be noted herein that the illustrated example is an exemplary embodiment and values of pressure and velocity regimes may vary depending on the application. In the illustrated embodiment, three applications are illustrated. Namely, bell crank application, ball bearing application, and gearbox application, represented by reference numerals 76, 78, and 80 respectively. For bell crank application, operating regimes include speed of 0.015 m/sec and pressure of 0.2 GPa. For ball bearing application, operating speed is 0.384 m/sec and pressure is the range of 0.75 to 1.5 GPa. For gearbox application, maximum operating speed is 0.5 m/sec and pressure is the range of 1.6 to 2 GPa. It should be noted herein that the values of operating speed and pressure in the foregoing embodiments are exemplary values and should not be construed as limiting values. The values may vary depending upon the application. All the three applications involve sliding and rolling motion between mating components.

In applications such as wind turbines, gearboxes operate under extreme conditions of lower speed and higher loads on the meshing gear tooth as disclosed in the illustrated FIG. 5. Also, the lubrication phenomenon is transient in nature because of inherent dynamics of a gear. Further, transient events like emergency stops during operation, further load the gears under which sustaining film formation between mating gears becomes very difficult. As a result, wind turbine gearboxes operate with a varying “film parameter” ratio during the meshing cycle. It should be noted herein that the “film parameter” is the ratio of film thickness to composite surface roughness of the two mating gears. For gears operating under loads of 1.6 GPa and sliding velocities of 0.5 m/s, the film parameter is less than or equal to 0.8. In general, gearbox operating with the film parameter less than or equal to 0.8 may cause higher friction and wear of gears. A textured surface in the form of dimples in gears provides enhanced lubrication and enhances performance of the gear system.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A gearbox, comprising:
a gearbox housing;
a plurality of gear sets disposed within the gearbox housing; wherein each gear set comprises at least two gears meshing with one another; wherein each gear comprises one or more dimpled surfaces configured to hold lubricant for providing lubrication between the gears meshing with one another; and
a plurality of bearings operable to support the plurality of gear sets.

2. The gearbox of claim 1, wherein the dimpled surface comprises a plurality of dimples formed in a predetermined pattern.

3. The gearbox of claim 2, wherein depth of the dimples is in the range from about 1 Amicron to about 50 microns.

4. The gearbox of claim 2, wherein depth of the dimples is in the range from about 30 microns to about 50 microns.

5. The gearbox of claim 2, wherein diameter of the dimples is in the range from about 50 microns to about 200 microns.

6. The gearbox of claim 2, wherein diameter of the dimples is in the range from about 80 microns to about 150 microns.

7. The gearbox of claim 2, wherein spacing between adjacent dimples is in the range from about 50 microns to about 300 microns.

8. The gearbox of claim 2, wherein spacing between adjacent dimples is in the range from about 150 microns to about 300 microns.

9. The gearbox of claim 2, wherein spacing between adjacent dimples is in the range from about 100 microns to about 150 microns, diameter of the dimples is in the range from about 50 microns to about 150 microns, and depth of the dimples is in the range from about 5 microns to about 10 microns.

10. A gear, comprising:
one or more dimpled surfaces configured to hold lubricant for providing lubrication to the gear.

11. The gear of claim 10, wherein the dimpled surface comprises a plurality of dimples formed in a predetermined pattern.

12. The gear of claim 11, wherein depth of the dimples is in the range from about 1 micron to 50 microns.

13. The gear of claim 11, wherein depth of the dimples is in the range from about 30 microns to about 50 microns.

14. The gear of claim 11, wherein diameter of the dimples is in the range from about 50 microns to about 200 microns.

15. The gear of claim 11, wherein diameter of the dimples is in the range from about 80 microns to about 150 microns.

16. The gear of claim 11, wherein spacing between adjacent dimples is in the range from about 50 microns to about 300 microns.

17. The gear of claim 11, wherein spacing between adjacent dimples is in the range from about 150 microns to about 300 microns.

18. A wind turbine comprising:
a rotor;
a generator operable to generate power;
a gearbox provided between the rotor and the generator; the gearbox comprising:
a gearbox housing;
a plurality of gear sets disposed within the gearbox housing; wherein each gear set comprises at least two gears meshing with one another; wherein each gear comprises one or more dimpled surfaces configured to hold lubricant for providing lubrication between the gears meshing with one another; and
a plurality of bearings operable to support the plurality of gear sets.

19. The wind turbine of claim 18, wherein the gearsets are operated at a sliding velocity less than or equal to 0.5 meters per second.

20. The wind turbine of claim 18, wherein load exerted on the gearsets is in the range of 1.6 gigapascals to 2 gigapascals.

21. The wind turbine of claim 18, wherein the dimpled surface comprises a plurality of dimples formed in a predetermined pattern.

22. The wind turbine of claim 21, wherein depth of the dimples is in the range from about 1 microns to about 50 microns.

23. The wind turbine of claim 21, wherein diameter of the dimples is in the range from about 50 microns to about 200 microns.

24. The wind turbine of claim 21, wherein spacing between adjacent dimples is in the range from about 50 microns to about 300 microns.

25. The wind turbine of claim 21, wherein spacing between adjacent dimples is in the range from about 100 microns to about 150 microns, diameter of the dimples is in the range from about 50 microns to about 150 microns, and depth of the dimples is in the range from about 5 microns to about 10 microns.
